(19) United States
(12) Patent Application Publication
(10) Pub. No.: US 2013/0322866 A1
(43) Pub. Date: Dec. 5, 2013

(54) BLADE DRIVE DEVICE AND OPTICAL EQUIPMENT

(71) Applicant: SEIKO PRECISION INC., Narashino-shi (JP)

(72) Inventor: Mitsuru SUZUKI, Narashino-shi (JP)

(73) Assignee: SEIKO PRECISION INC., Narashino-shi (JP)

(21) Appl. No.: 13/961,137

(22) Filed: Aug. 7, 2013

Related U.S. Application Data
(63) Continuation of application No. PCT/JP2011/077147, filed on Nov. 25, 2011.

(30) Foreign Application Priority Data
Mar. 31, 2011 (JP) 2011-079735

(51) Int. Cl. G03B 9/10

(52) U.S. Cl. CPC G03B 9/10
USPC 396/493

(57) ABSTRACT

A blade drive device includes: a blade; a board including an opening opened and closed by the blade; an actuator including a rotor; an output member driven by the rotor; a drive member rotatable relative to the board in response to the output member; a driven member driving the blade in response to the drive member; and a holder holding the actuator, wherein the holder includes an escape hole, the drive member includes: a support portion rotatably supported; a first connection portion connected with the output member; and a second connection portion connected with the driven member, and the first connection portion is positioned in the escape hole between the second connection portion and the support portion.

### CROSS-REFERENCE TO RELATED APPLICATION

This application is a continuation of and claims priority to International Patent Application No. PCT/JP2011/077147 filed on Nov. 25, 2011, which claims priority to Japanese Patent Application No. 2011-079735 filed on Mar. 31, 2011, subject matter of these patent documents is incorporated by reference herein in its entirety.

### BACKGROUND

(i) Technical Field

The present invention relates to blade drive devices and optical equipment.

(ii) Related Art

Japanese Unexamined Patent Application Publication No. 2004-325673 discloses a device including: a rotor; a drive lever to which the drive force of the rotor is transmitted; a sector drive lever rotating in response to the drive lever; arms driven by the sector drive lever; blades driven by the arms; and a board having an opening opened and closed by the blades.

The sector drive lever has a spindle portion for being rotatably supported with respect to the board. Also, the sector drive lever has a gear portion meshing with the drive lever and a drive pin connected with the arm. The spindle portion is located between the gear portion and the drive pin. Therefore, there is a problem with reducing the diameter of the spindle portion, since a large load is applied to the spindle portion. Therefore, the spindle portion might not be reduced in size, so the whole device might not be reduced in size.

### SUMMARY

It is thus object of the present invention to provide a blade drive device having a reduced size and an optical equipment having the same.

According to an aspect of the present invention, there is provided a blade drive device a blade drive device including: a blade; a board including an opening opened and closed by the blade; an actuator including a rotor; an output member driven by the rotor; a drive member rotatable relative to the board in response to the output member; and a holder holding the actuator, wherein the holder includes an escape hole, the drive member includes: a support portion rotatably supported; a first connection portion connected with the output member; and a second connection portion connected with the blade, and the first connection portion is positioned in the escape hole between the second connection portion and the support portion.

### BRIEF DESCRIPTION OF THE DRAWINGS

FIG. 1 is an exploded perspective view of a blade drive device according to the present embodiment;

FIG. 2 is an exploded perspective view of the blade drive device according to the present embodiment;

FIG. 3 is an enlarged view of a rotor, a drive member, and an output member;

FIG. 4 is a sectional view around a leading blade, the drive member, the output member, and an actuator;

FIGS. 5A and 5B are explanatory views of load applied to the drive member;

FIG. 6 is a perspective view of the drive member, the output member, and the rotor when viewed in an axial direction of an opening, and

FIG. 7 is a sectional view of a blade drive device according to a variation.

### DETAILED DESCRIPTION

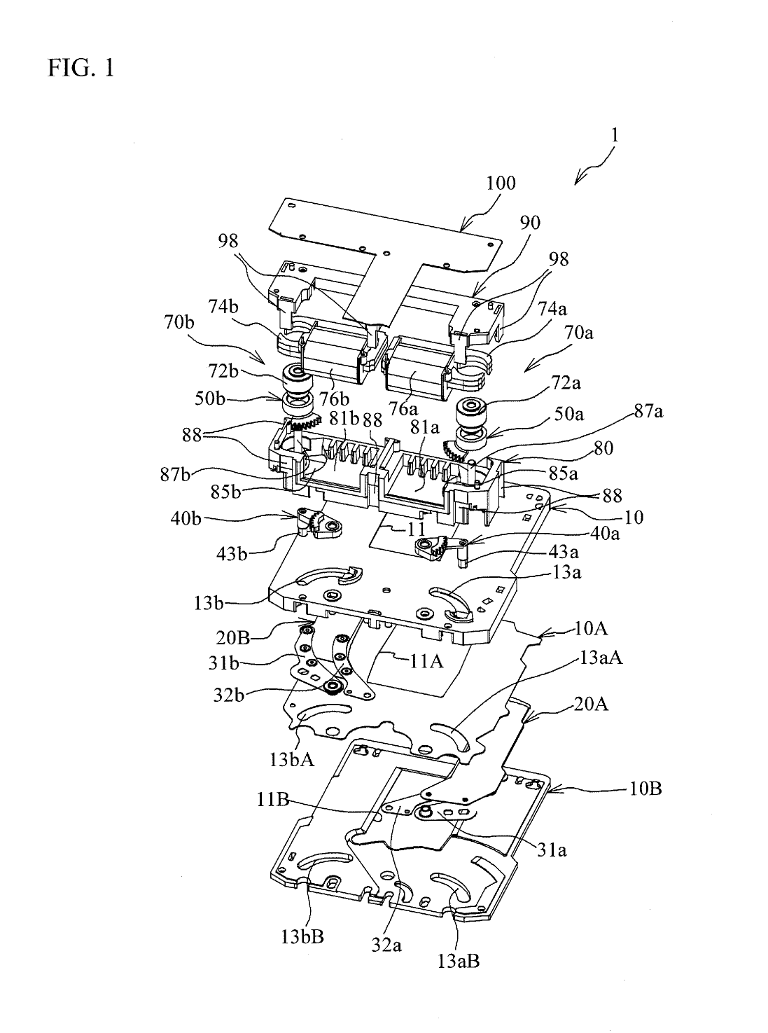

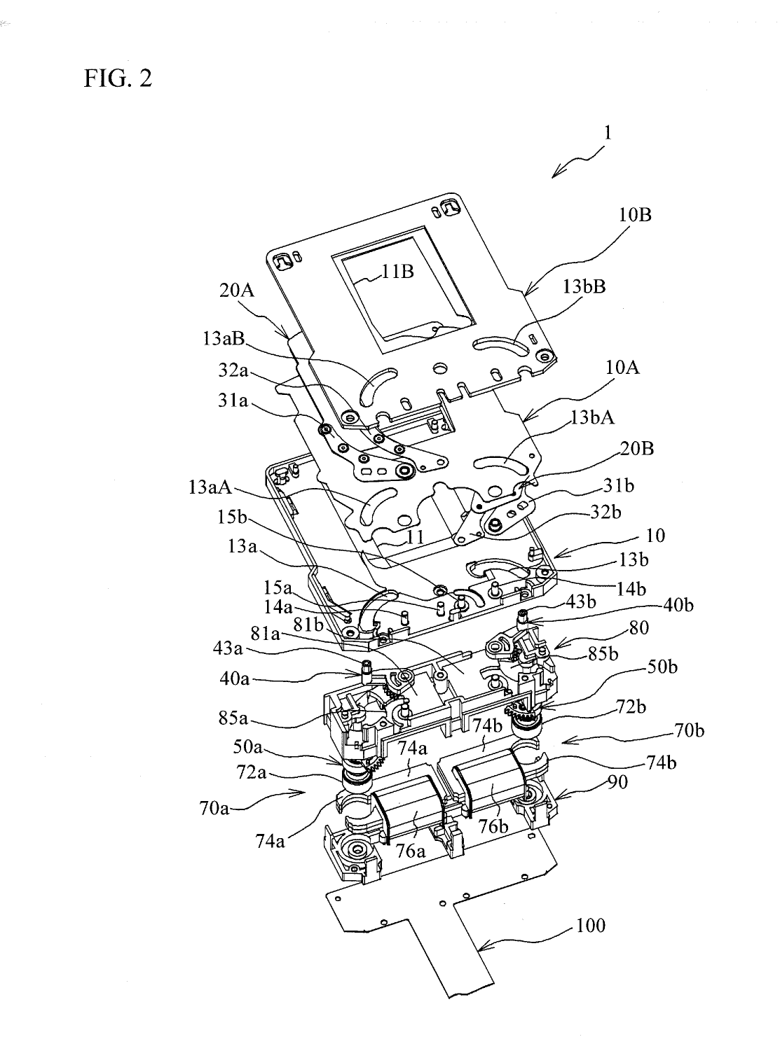

FIGS. 1 and 2 are exploded perspective views of a blade drive device 1 according to the present embodiment. The blade drive device 1 is also referred to as a focal plane shutter. The blade drive device 1 is employed in optical equipment such as a digital camera or a still camera. The blade drive device 1 includes boards 10, 10A, and 10B, a leading blade 20A, a trailing blade 20B, arms 31a, 32a, 31b, and 32b, and actuators 70a and 70b. The boards 10, 10A, and 10B respectively include openings 11, 11A, and 11B. The leading blade 20A and the trailing blade 20B open and close these openings 11, 11A, and 11B. The actuators 70a and 70a drive the leading blade 20A and the trailing blade 20B, respectively.

The leading blade 20A and the trailing blade 20B each includes plural blades. Each of the leading blade 20A and the trailing blade 20B can shift between an overlapped state where the plural blades overlap one another and an expanded state where the plural blades are expanded. These plural blades in the overlapped state recede from the opening 11 to cause the opening 11 to be in a fully opened state. These plural blades in the expanded state close the opening 11 to cause the opening 11 to be in a fully closed state. FIGS. 1 and 2 illustrate the blade drive device 1 in the fully opened state.

The leading blade 20A is connected with the arms 31a and 32a. The trailing blade 20B is connected with the arms 31b and 32b. As illustrated in FIG. 2, the arms 31a, 32a, 31b, and 32b are rotatably supported by spindles 14a, 15a, 14b, and 15b provided in the board 10, respectively.

Drive members 40a and 40b drive the arms 31a and 31b, respectively. Thus, the arms 31a and 31b correspond to driven members that are driven by the drive members 40a and 40b and that drive the leading blade 20A and the trailing blade 20B, respectively. The drive members 40a and 40b are provided with drive pins 43a and 43b connected with the arms 31a and 31b, respectively. The boards 10, 10A, and 10B are respectively formed with escape slots 13a, 13aA, and 13aB for permitting the movement of the drive pin 43a. Likewise, they are respectively formed with escape slots 13b, 13bA, and 13bB for permitting the movement of the drive pin 43b.

The drive members 40a and 40b will be described later in detail.

The board 10 is assembled with holders 80 and 90 holding the actuators 70a and 70b. The holder 80 is formed with support walls 81a and 81b that respectively support the actuators 70a and 70b. The holder 80 is secured on the board 10. The holders 80 and 90 are secured to each other. The holder 90 is provided with plural engaging claws 98. The holder 80 is provided with plural engaging portions 88 which are respectively engaged with the engaging claws 98. The holders 80 and 90 are secured to each other by engaging the engaging claws 98 with the engaging portions 88. The holders 80 and 90 are made of a synthetic resin.

The actuator 70a includes: a rotor 72a rotatably supported by the holder 80; a stator 74a excited to generate magnetic force between the stator and the rotor 72a; and a leading blade coil 76a for exciting the stator 74a. The rotor 72a is fitted with an output member 50a as will be described later in detail. The output member 50a is connected with the drive member 40a. Therefore, the rotation of the rotor 72a drives the output member 50a and the drive member 40a to drive the arm 31a and the leading blade 20A. The actuator 70b has the same arrangement. The rotation of a rotor 72b of the actuator 70b drives the drive member 40b to drive the trailing blade 20B.

The support walls 81a and 81b of the holder 80 are respectively formed with escape holes 85a and 85b. The escape hole 85a receives a connection portion where the drive member 40a and the output member 50a are connected with each other. Likewise, the escape hole 85b receives a connection portion where the drive member 40b and an output member 50b are connected with each other. The holder 80 is formed with spindle portions 87a and 87b for supporting the rotors 72a and 72b for rotation, respectively. A printed circuit board 100 is secured on an upper portion of the holder 90. The printed circuit board 100 supplies the coils 76a and 76b with power.

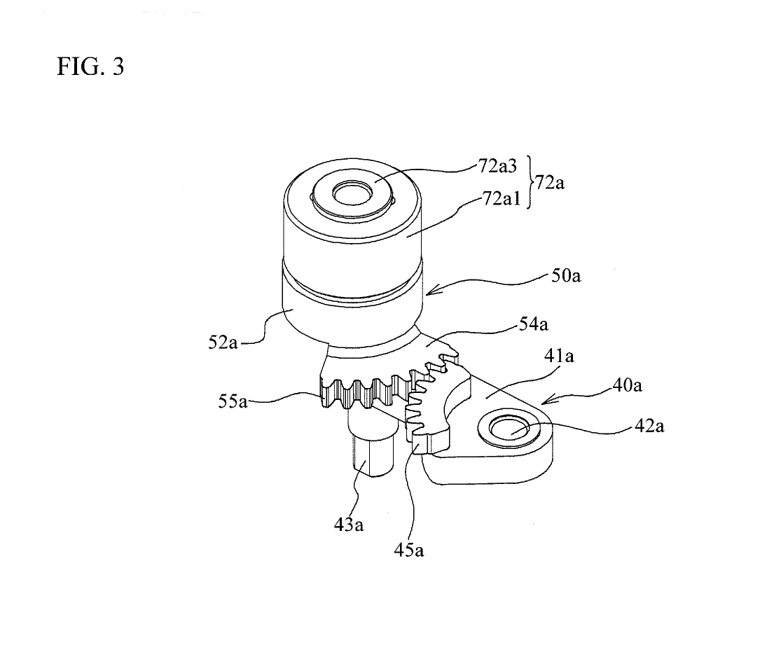

FIG. 3 is an enlarged view of the rotor 72a, the drive member 40a, and the output member 50a. Additionally, FIG. 3 illustrates a state where the rotor 72a, the drive member 40a, and the output member 50a are assembled into the blade drive device 1. The drive member 40a includes: an arm portion 41a having a plate shape; a support hole 42a formed at one end of the arm portion 41a and serving as a fulcrum of rotation; and the drive pin 43a formed at the other end of the arm portion 41a and extending in a predetermined direction. Also, a gear portion 45a is formed on the upper portion of the arm portion 41a. The rotor 72a includes a cylindrical portion 72a3, and a permanent magnet 72a1 having a ring shape and fitted with the cylindrical portion 72a3. The permanent magnet 72a1 is energized to have different polarities in the circumferential direction. The permanent magnet 72a1 is fitted with the upper side of the cylindrical portion 72a3 and is not rotated relative thereto. The output member 50a is fitted with the lower side of the cylindrical portion 72a3 and is not rotated relative thereto. Thus, the output member 50a rotates together with the rotor 72a. The permanent magnet 72a1 and the cylindrical portion 72a3 are integrally formed with each other.

The output member 50a includes: a cylindrical portion 52a having a substantially cylindrical shape and fitted with the cylindrical portion 72a3; a projection portion 54a projecting from the cylindrical portion 52a in the radially outward direction; and a gear portion 55a formed at one end of the projection portion 54a. The gear portion 55a of the output member 50a meshes with the gear portion 45a of the drive member 40a. Thus, the force of the output member 50a is transmitted to the drive member 40a. Therefore, the gear portion 45a of the drive member 40a corresponds to a first connection portion connected with the output member 50a.

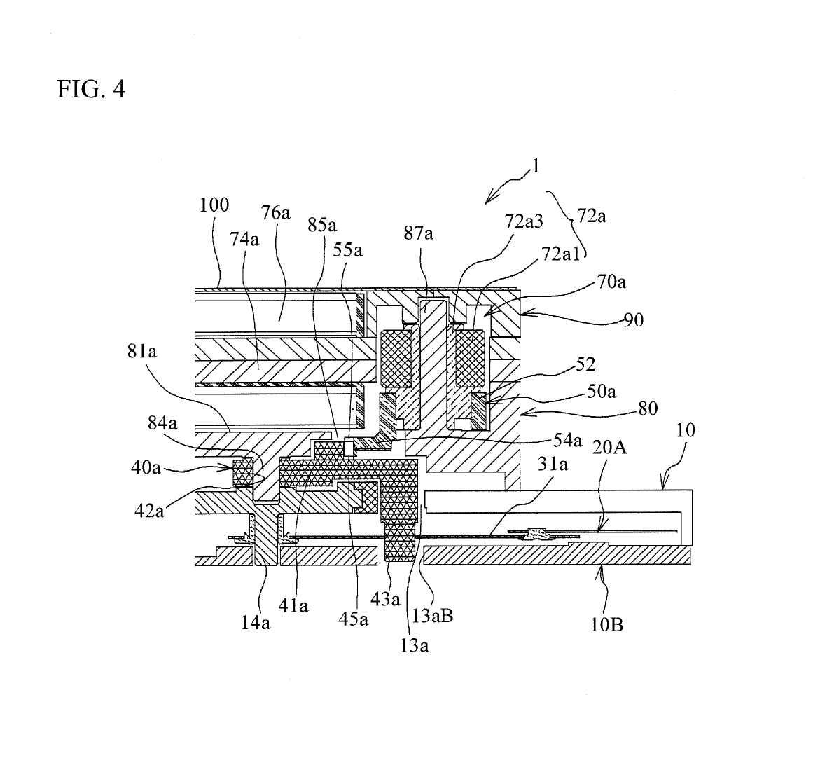

FIG. 4 is a sectional view around the leading blade 20A, the drive member 40a, the output member 50a, and the actuator 70a. Additionally, FIG. 4 is the sectional view of the blade drive device 1 viewed in the direction perpendicular to the axial direction of the opening 11. The board 10A is omitted in FIG. 4. The support hole 42a of the drive member 40a is rotatably fitted onto a spindle 84a of the holder 80. Accordingly, the drive member 40a is rotatably supported. Thus, the support hole 42a corresponds to a support portion that rotatably supports the drive member 40a. The drive pin 43a extends in a predetermined direction and is connected with the arm 31a arranged between the boards 10 and 10B. Thus, the drive pin 43a of the drive member 40a corresponds to a second connection portion connected with the arm 31a. As mentioned above, the arm 31a is connected with the leading blade 20A. The connection between the output member 50a and the drive member 40a is ensured through the escape hole 85a. Specifically, the gear portions 45a and 55a are positioned in the escape hole 85a.

Also, as illustrated in FIGS. 3 and 4, the gear portion 45a of the drive member 40a is positioned between the support hole 42a and the drive pin 43a. Therefore, the load applied to the spindle 84a fitted into the support hole 42a can be reduced, thereby making the diameter of the spindle 84a smaller than conventional one. A following description will be given of the load exerted on the drive member 40a.

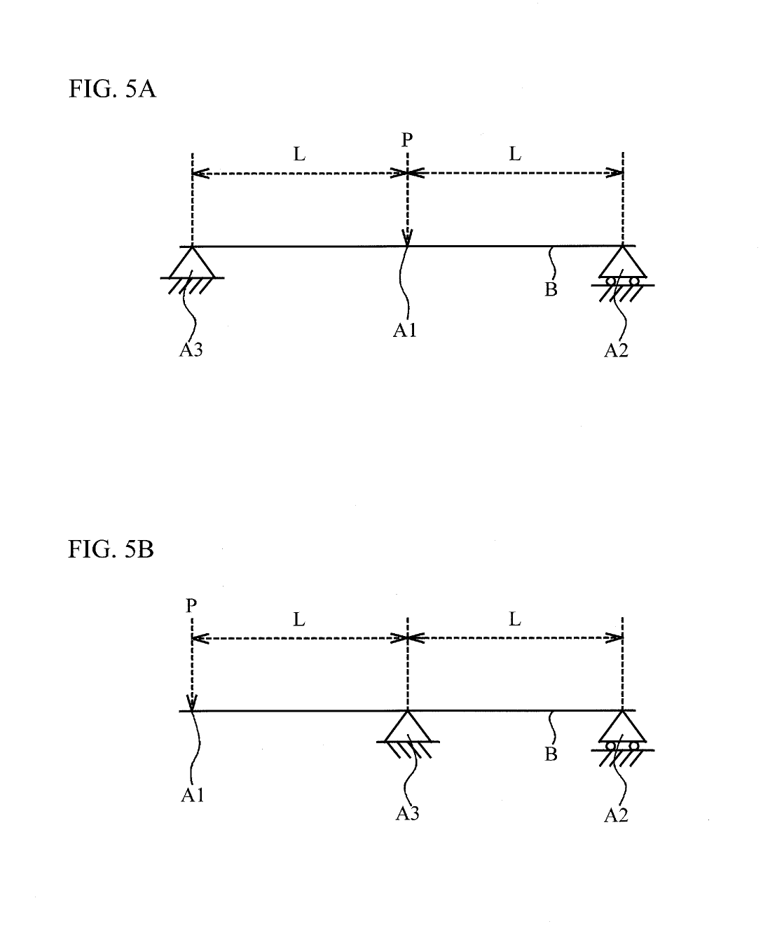

FIGS. 5A and 5B are explanatory views of the load exerted on the drive member 40a. FIG. 5A is the explanatory view of the load exerted on the drive member 40a in the present embodiment, and FIG. 5B is the explanatory view of the load exerted on a drive member having a structure different from the present embodiment. In the present embodiment, the arm portion 41a of the drive member 40a is formed with the drive pin 43a fitted into the arm 31a, and the support hole 42a fitted with the spindle 84a. Thus, the arm portion 41a of the drive member 40a can be considered as a both-end-supported beam B that is supported at points A2 and A3, as illustrated in FIG. 5A. The point A3 corresponds to the support hole 42a. The point A2 corresponds to the second connection portion where the arm 31a is connected with the drive member 40a. Herein, it can be considered that the gear portion 45a formed on the arm portion 41a to which the force is transmitted from the output member 50a is a load P exerted on the beam B. The length of the beam B is represented by 2L. A point A1 where the load P is exerted is considered as the center of the beam B. The point A1 corresponds to the first connection portion where the drive member 40a and the output member 50a are connected with each other. In this case, the magnitude of the shear stress in the point A3 is P/2. The magnitude of the bending moment in the point A3 is zero.

In contrast, in FIG. 5B, the point A1 where the load is exerted is positioned outside the point A3, and the point A3 is positioned between the points A1 and A2. That is, FIG. 5B illustrates a conventional structure where the support hole 42a of the present embodiment is positioned between the gear portion 45a and the drive pin 43a of the drive member 40a. As mentioned above, the point A3 means the fulcrum where the drive member 40a is rotatably supported. Therefore, a part of the beam B between the points A1 and A3 can be considered as a cantilever beam that is supported at the point A3. The magnitude of the shear stress exerted on the point A3 is P. The magnitude of the bending moment exerted on the point A3 is PL. Thus, the shear stress and the bending moment exerted on the point A3 of the beam B illustrated in FIG. 5A are smaller than those of the beam B illustrated in FIG. 5B, respectively.

Thus, in the present embodiment, the large load is not applied to the spindle 84a that rotatably fits into the support hole 42a of the drive member 40a. Accordingly, it is possible to make the diameter of the spindle 84a smaller than that of the conventional structure where the support hole 42a is arranged between the gear portion 45a and the drive pin 43a. This reduces the size of the blade drive device 1 in the planar direction.

Also, as illustrated in FIG. 4, the gear portion 45a of the drive member 40a and the gear portion 55a of the output member 50a are positioned in the escape hole 85a of the holder 80. This reduces the thickness of the blade drive device 1.

Also, the size of the escape hole 85a is set so as to permit the connection between the gear portions 45a and 55a. Thus, the escape hole 85a is comparatively large. This reduces the weight of the holder 80.

Also, the gear portions 45a and 55a are connected with each other in the escape hole 85a, thereby arranging the drive member 40a and the output member 50a close to each other. This reduces the whole size of the drive member 40a and the output member 50a. Further, this reduces the total weight of the drive member 40a and the output member 50a. Thus, the blade drive device 1 is reduced in weight.

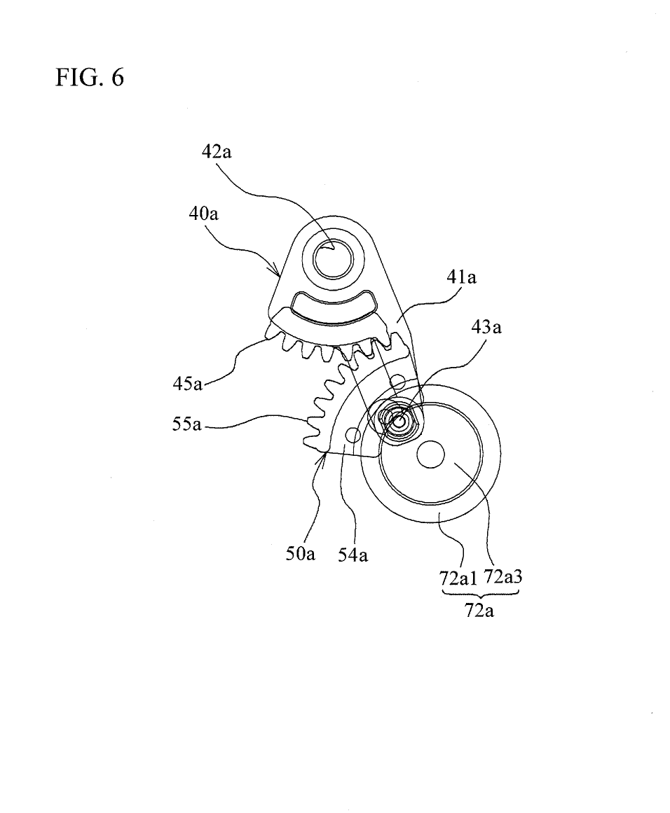

FIG. 6 is a perspective view of the drive member 40a, the output member 50a, and the rotor 72a when viewed in the axial direction of the opening 11. In other words, FIG. 6 is the perspective view of the drive member 40a, the output member 50a, and the rotor 72a when viewed in the axial direction of the rotor 72a. As illustrated in FIG. 6, the drive pin 43a overlaps the rotor 72a. Specifically, a part of a trajectory of the drive pin 43a overlaps the rotor 72a. The rotor 72a and the drive member 40a are arranged in such a manner, thereby reducing the size of the blade drive device 1 in the planar direction. Additionally, as illustrated in FIG. 6, the gear portion 45a is arranged on a straight line that connects between the center of the support hole 42a and the center of the drive pin 43a.

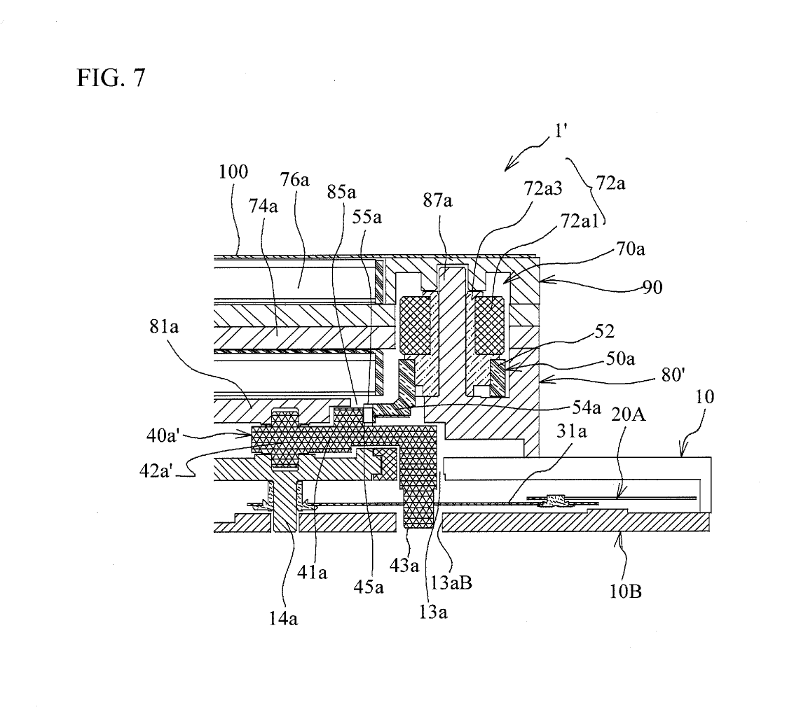

FIG. 7 is a sectional view of a blade drive device 1′ according to a variation. FIG. 7 corresponds to FIG. 4. A drive member 40a′ includes a support spindle 42a′. The support spindle 42a′ is rotatably fitted within each hole formed in a holder 80′ and the board 10. Thus, the support spindle 42a′ corresponds to a support portion that rotatably supports the drive member 40a′. In such a manner, the drive member 40a′ may be rotated by the support spindle 42a′. In such a configuration, the load exerted on the support spindle 42a′ is small. It is thus possible to make the size of the diameter of the support spindle 42a′ small, thereby reducing the size of the blade drive device 1′.

In the embodiment according to the present invention, the blade drive device 1 has been descried as the focal plane shutter. The focal plane shutter according to the present invention is not a type for using springs as drive sources of the leading blade 20A and the trailing blade 20B, but a type for using the electromagnetic actuators 70a and 70b. In a general focal plane shutter, the space, in which a blade drive mechanism for driving the leading blade and the trailing blade can be configured, is limited to a region near one of the short sides of the opening 11 on the board 10 in the present embodiment, that is, a region defined by the holders 80 and 90 on the board 10.

In a case of the focal plane shutter equipped with the leading blade and the trailing blade driven by the electromagnetic actuators 70a and 70b, in order to ensure high speed in these days, the space might be needed for a coil. Thus, the blade drive mechanism might be increased in size. In the focal plane shutter according to the present embodiment, the gear portion 45a of the drive member 40a is positioned between the support hole 42a and the drive pin 43a, and the large load is not applied to the spindle 84a. This can make the diameter of the spindle 84a small. Also, the trajectory of the drive pin 43a partially overlaps the rotor 72a, thereby reducing the size of the blade drive mechanism in the planar direction. Further, the gear portion 45a of the driving member 40a and the gear portion 55a of the output member 50a are arranged in the escape hole 85a, whereby the thickness of the blade drive mechanism can be reduced in thickness direction, that is, in the direction of the spindle 84a. Thus, in the focal plane shutter of the blade drive device 1 according to the present invention, the thickness thereof is reduced in the optical axis direction parallel to the spindle 84a, and the size is reduced in the direction perpendicular to the optical axis direction.

While the exemplary embodiments of the present invention have been illustrated in detail, the present invention is not limited to the above-mentioned embodiments, and other embodiments, variations and modifications may be made without departing from the scope of the present invention.

In the above present embodiment, the focal plane shutter has been described as one example of the blade drive device. However, the blade drive device may not be the focal plane shutter. For example, a blade may be directly connected with the drive pin 43a of the drive member 40a. Also, a blade is not limited to one linearly moving. A blade may rotate or swing.

Finally, several aspects of the present invention are summarized as follows.

According to an aspect of the present invention, there is provided a blade drive device including: a blade; a board including an opening opened and closed by the blade; an actuator including a rotor; an output member driven by the rotor; a drive member rotatable relative to the board in response to the output member; and a holder holding the actuator, wherein the holder includes an escape hole, the drive member includes: a support portion rotatably supported; a first connection portion connected with the output member; and a second connection portion connected with the blade, and the first connection portion is positioned in the escape hole between the second connection portion and the support portion.

Thus, the load applied to the support portion can be reduced. This can reduce the diameter of the support portion. It is thus possible to reduce the size of the blade drive device.

According to another aspect of the present invention, there is provided a blade drive device including: a blade; a board including an opening opened and closed by the blade; an actuator including a rotor; an output member driven by the rotor; a drive member rotatable relative to the board in response to the output member and driving the blade; and a holder holding the actuator, wherein the holder includes an escape hole, the drive member includes: a support portion rotatably supported; a first connection portion connected with the output member; and a second connection portion connected with the blade, and the first connection portion is positioned in the escape hole between the second connection portion and the support portion.

Another aspect of the present invention, there is provided an optical equipment having the above blade drive device.

What is claimed is:

1. A blade drive device comprising:
a blade;
a board including an opening opened and closed by the blade;
an actuator including a rotor;
an output member driven by the rotor;
a drive member rotatable relative to the board in response to the output member;
a driven member driving the blade in response to the drive member; and
a holder holding the actuator,
wherein the holder includes an escape hole,
the drive member includes:
a support portion rotatably supported;
a first connection portion connected with the output member; and
a second connection portion connected with the driven member, and
the first connection portion is positioned in the escape hole between the second connection portion and the support portion.

2. A blade drive device comprising:
a blade;
a board including an opening opened and closed by the blade;
an actuator including a rotor;
an output member driven by the rotor;
a drive member rotatable relative to the board in response to the output member and driving the blade; and
a holder holding the actuator,
wherein the holder includes an escape hole,
the drive member includes:
a support portion rotatably supported;
a first connection portion connected with the output member; and
a second connection portion connected with the blade, and
the first connection portion is positioned in the escape hole between the second connection portion and the support portion.

3. The blade drive device of claim 1, wherein at least a part of a trajectory of the second connection portion overlaps the rotor when viewed in an axial direction of the rotor.

4. The blade drive device of claim 1, wherein the first connection portion is a gear portion meshing with the output member.

5. The blade drive device of claim 1, wherein the first connection portion is positioned on a straight line connected between the second connection portion and the support portion.

6. The blade drive device of claim 2, wherein at least a part of a trajectory of the second connection portion overlaps the rotor when viewed in an axial direction of the rotor.

7. The blade drive device of claim 2, wherein the first connection portion is a gear portion meshing with the output member.

8. The blade drive device of claim 2, wherein the first connection portion is positioned on a straight line connected between the second connection portion and the support portion.

9. An optical equipment comprising a blade drive device including:
a blade;
a board including an opening opened and closed by the blade;
an actuator including a rotor;
an output member driven by the rotor;
a drive member rotatable relative to the board in response to the output member;
a driven member driving the blade in response to the drive member; and
a holder holding the actuator,
wherein the holder includes an escape hole,
the drive member includes:
a support portion rotatably supported;
a first connection portion connected with the output member; and
a second connection portion connected with the driven member, and
the first connection portion is positioned in the escape hole between the second connection portion and the support portion.

10. An optical equipment comprising a blade drive device including:
a blade;
a board including an opening opened and closed by the blade;
an actuator including a rotor;
an output member driven by the rotor;
a drive member rotatable relative to the board in response to the output member and driving the blade; and
a holder holding the actuator,
wherein the holder includes an escape hole,
the drive member includes:
a support portion rotatably supported;
a first connection portion connected with the output member; and
a second connection portion connected with the blade, and
the first connection portion is positioned in the escape hole between the second connection portion and the support portion.
